(19) United States
(12) Patent Application Publication
(10) Pub. No.: US 2006/0233255 A1
(43) Pub. Date: Oct. 19, 2006

(54) Fine granularity scalability (FGS) coding efficiency enhancements

(75) Inventors: Justin Ridge, Irving, TX (US); Yiliang Bao, Irving, TX (US); Marta Karczewicz, Irving, TX (US); Xianglin Wang, Irving, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/402,517

(22) Filed: Apr. 12, 2006

Related U.S. Application Data
(60) Provisional application No. 60/670,748, filed on Apr. 13, 2005.

(51) Int. Cl. H04N 11/04; H04N 7/12; H04N 11/02; H04B 1/66

(52) U.S. Cl. 375/240.18; 375/240.24

(57) ABSTRACT

Scalable video coding techniques include encoding blocks by scan position within a coding cycle in decreasing order to increase the probability of the next symbol will be non-zero. When truncating a fine granularity singularity (FGS) slice, instead of removing a constant fraction of every slice, the fraction is a truncation ration that is set to depend on the temporal level of the slice being truncated.

### CROSS REFERENCE TO RELATED APPLICATIONS

The present application is related to U.S. patent application Ser. No. 11/028,899 entitled METHOD AND SYSTEM FOR CODING/DECODING OF A VIDEO BIT STREAM FOR FINE GRANULARITY SCALABILITY, filed on Jan. 3, 2005, and U.S. patent application No. 60/670,748 entitled FINE GRANULARITY SCALABILITY (FGS) CODING EFFICIENCY ENHANCEMENTS, filed on Apr. 13, 2005, both assigned to the same assignee as the present application.

### FIELD OF THE INVENTION

The present invention relates generally to scalable video coding methods and systems. More specifically, the present invention relates to techniques for fine granularity scalability (FGS) coding.

### BACKGROUND INFORMATION

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

In general, conventional video coding standards (e.g., MPEG-1, H.261/263/264) incorporate motion estimation and motion compensation to remove temporal redundancies between video frames in multimedia applications and services. Scalable video coding is a desirable feature for many multimedia applications and services used in systems employing decoders with a wide range of processing power. Several types of video scalability schemes have been proposed, such as temporal, spatial and quality scalability.

In some scenarios, it is desirable to transmit an encoded digital video sequence at some minimum or “base” quality, and in concert transmit an “enhancement” signal that may be combined with the minimum quality signal in order to yield a higher-quality decoded video sequence. Such an arrangement simultaneously allows some decoding of the video sequence by devices supporting some set of minimum capabilities (at the “base” quality), while enabling other devices with expanded capability to decode higher-quality versions of the same sequence, without incurring the increased cost associated with transmitting two independently coded versions of the same sequence.

For scalable video coding, it is desirable to encode the video sequence once, and to be capable of extracting a portion of the bit stream in such a way that it is possible to decode the extracted portion while permitting some deterioration (e.g. lower spatial resolution, lower quality). In some situations, more than two levels of quality may be desired. For example, multiple “enhancement” signals can be transmitted, each building on the “base” quality signal plus all lower-quality “enhancement” signals. Such “base” and “enhancement” signals are referred to as “layers” in the filed of scalable video coding, and the degree to which each enhancement layer improves on the reconstructed quality of the signal is referred to as the “granularity.” Fine granularity scalability (FGS) is a type of scalability in which the incremental quality increases provided by each layer are relatively small.

Extraction should require a minimal amount of processing. One of the least complex methods of extraction is to truncate the FGS layer to a desired length. This is the method currently used in the H.264/AVC scalable extension working draft, MPEG document w6901, “Working Draft 1.0 of 14496-10:200x/AMD1 Scalable Video Coding”, Hong Kong meeting, January 2005.

Within an FGS layer, all information is not “equally useful.” For example, values of “zero” do not change the base layer reconstruction, and therefore contribute no valuable information. Consequently, it is desirable to structure the FGS bit stream such that the “most valuable” information (roughly equivalent to the symbols with greatest non-zero probability) appear first, so that this valuable information is not lost when/if the FGS layer is truncated. U.S. patent application Ser. No. 11/028,899, which is herein incorporated by reference in its entirety, describes a method for achieving this object.

Other structures and methodologies can be used to achieve FGS and improve coding efficiency. There is a need for an improved FGS coder that is more flexible than previous schemes. There is also a need for a FGS coding scheme that provides an overall improvement in coding efficiency.

### SUMMARY OF THE INVENTION

Embodiments of the present invention disclose methods, computer code products, and devices for encoding and/or decoding video data. In various embodiments of the invention the video data comprises multiple components, each component having multiple coefficients. The video data can be encoded or decoded in multiple passes.

According to embodiments of the present invention, scalable video coding techniques can include encoding blocks by scan position within a coding cycle in decreasing order to increase the probability of the next symbol will be non-zero. Further, when truncating a FGS slice, instead of removing a constant fraction of every slice, the fraction is set to depend on the temporal level.

One exemplary embodiment relates to a method of decoding scalable video data. This method can include identifying one or more coefficient blocks in a frame of scalable video data to be decoded during a decoding pass, computing a scan position for each identified coefficient block, processing the identified coefficient blocks in an order based in part on the computed scan positions corresponding to the identified coefficient blocks, and decoding zero or more coefficients for each of the processed coefficient blocks.

Another exemplary embodiment relates to a method of processing scalable video data. This method can include parsing a bit stream containing scalable video data, selectively removing elements from one or more slices of scalable video data based on a temporal level of the one or more slices of scalable video data, and forming a new bit stream that does not include the elements removed from the one or more slices of scalable video data.

Another exemplary embodiment relates to a computer program product for coding a video sequence. This computer program product can include computer code configured to identify one or more coefficient blocks in a frame of scalable video data to be decoded during a decoding pass, compute a scan position for each identified coefficient block, process the identified coefficient blocks in an order based in part on the computed scan positions corresponding to the identified coefficient blocks, and decode zero or more coefficients for each of the processed coefficient blocks.

Another exemplary embodiment relates to a computer program product for coding a video sequence. This computer program product can include computer code configured to receive a bit stream containing a base quality signal and enhancement data that enhances the quality of the base quality signal and selectively remove elements from the enhancement data. The selective removal involves removing elements from a slice of enhancement data, and the elements removed from the slice are based on a temporal level of the slice.

Another exemplary embodiment relates to a device for coding and decoding a video sequence. This device can include a processor configured to execute instructions, memory configured for storing a computer program, and a computer program comprising instructions configured to cause the processor to identify one or more coefficient blocks in a frame of scalable video data to be decoded during a decoding pass, compute a scan position for each identified coefficient block, process the identified coefficient blocks in an order based in part on the computed scan positions corresponding to the identified coefficient blocks, decode zero or more coefficients for each of the processed coefficient blocks, receive a bit stream containing a base quality signal and enhancement data that enhances the quality of the base quality signal, and selectively remove elements from the enhancement data. The selective removal involves removing elements from a slice of enhancement data, and the elements removed from the slice are based on a temporal level of the slice.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF DRAWINGS

FIG. 1 is a perspective view of a communication device that can be used in an exemplary embodiment.

FIG. 2 is a block diagram illustrating an exemplary functional embodiment of the communication device of FIG. 1.

FIG. 3 is a block depicting coefficients in block-based video coding in accordance with an exemplary embodiment.

FIG. 4 is a flow diagram depicting operations performed in a method of determining an order in which blocks are processed in a given cycle in accordance with an exemplary embodiment.

FIG. 5 is a flow diagram depicting operations performed in a method of decoding scalable video data in accordance with an exemplary embodiment.

FIG. 6 is a diagram of a group of temporal levels for frames of the scalable video sequence in accordance with an exemplary embodiment.

FIG. 7 is a flow diagram depicting operations in the coding or decoding of a video sequence including a truncation ratio linked to a temporal level for a given frame in accordance with an exemplary embodiment.

### DETAILED DESCRIPTION OF EXEMPLARY EMBODIMENTS

Exemplary embodiments present methods, computer code products, and devices for efficient FGS encoding and decoding. Embodiments can be used to solve some of the problems inherent to existing solutions. For example, these embodiments can be used to improve the overall coding efficiency of an FGS scheme, to provide a more uniform/regular SNR characteristic, and to increase the flexibility of the system to provide added control, such as by controlling the luminance and chrominance bit distributions independently.

As used herein, the term “enhancement layer” refers to a layer that is coded differentially compared to some lower quality reconstruction. The purpose of the enhancement layer is that, when added to the lower quality reconstruction, signal quality should improve, or be “enhanced.” Further, the term “base layer” applies to both a non-scalable base layer encoded using an existing video coding algorithm, and to a reconstructed enhancement layer relative to which a subsequent enhancement layer is coded.

As noted above, embodiments include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions. Any common programming language, such as C or C++, or assembly language, can be used to implement the invention.

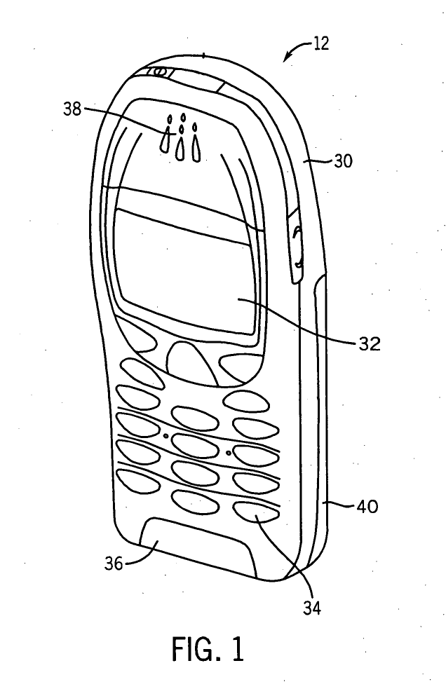

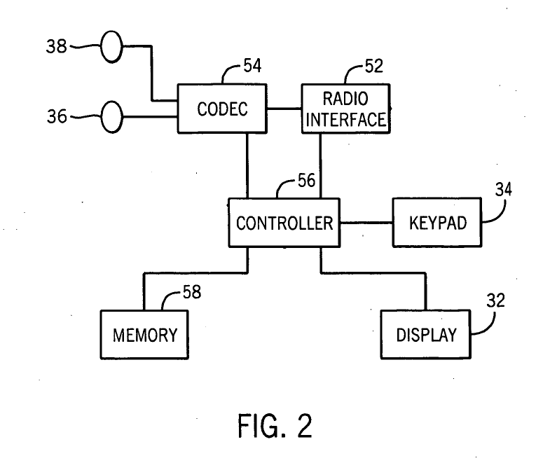

FIGS. 1 and 2 show an example implementation as part of a communication device (such as a mobile communication device like a cellular telephone, or a network device like a base station, router, repeater, etc.). However, it is important to note that the present invention is not limited to any type of electronic device and could be incorporated into devices such as personal digital assistants, personal computers, mobile telephones, and other devices. It should be understood that the present invention could be incorporated on a wide variety of devices.

The device 12 of FIGS. 1 and 2 includes a housing 30, a display 32, a keypad 34, a microphone 36, an ear-piece 38, a battery 40, radio interface circuitry 52, codec circuitry 54, a controller 56 and a memory 58. Individual circuits and elements are all of a type well known in the art, for example in the Nokia range of mobile telephones. The exact architecture of device 12 is not important. Different and additional components of device 12 may be incorporated into the device 12. The scalable video encoding and decoding techniques of the present invention could be performed in the controller 56 memory 58 of the device 12.

The exemplary embodiments are described in the general context of method steps or operations, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations could be accomplished with standard programming techniques with rule based logic and other logic to accomplish the various database searching steps, correlation steps, comparison steps and decision steps. It should also be noted that the words “module” as used herein and in the claims is intended to encompass implementations using one or more lines of software code, and/or hardware implementations, and/or equipment for receiving manual inputs.

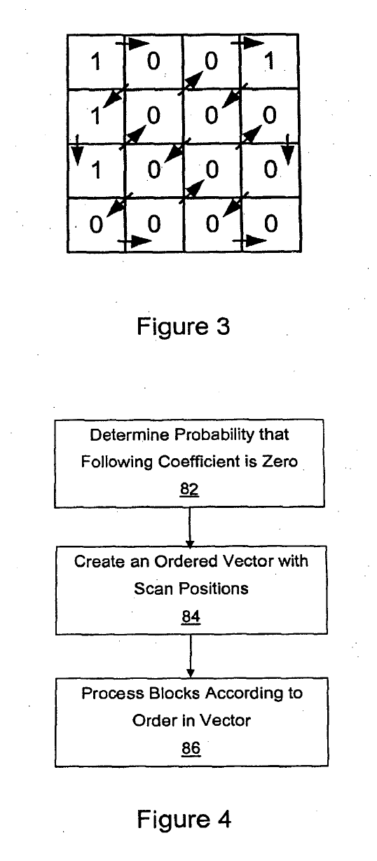

In block-based video coding, coefficients are processed in a “scan order”, sometimes also called a “zigzag scan order.” The “scan position” identifies which coefficient in the scan order is currently being processed. FIG. 3 illustrates an example 4×4 block in which arrows indicate the “scan order.” The coefficient at the first “scan position” is one, at the second “scan position” is zero, at the third “scan position” is one, and so on.

In sub-band coding, the coefficients at the first scan position of each block are processed; then the coefficients at the second scan position of each block; and so on. Therefore, in a given coding pass, the scan position is the same for each block. U.S. patent application Ser. No. 11/028,899 describes “cyclical block coding” in which the scan position restriction is removed, such that, for a given coding pass (or ‘cycle’) the scan position may differ from one block to another. Such a design improves the coding efficiency of FGS.

There is a statistical relationship between the scan position (or “scan index”) and the probability of the next coefficient being non-zero. It is desirable to send coefficients with the highest probability of being non-zero towards the start of the FGS bit stream, so that less meaningful information is removed should the FGS bit stream be truncated. Consequently, the scan position can be exploited to determine the order in which blocks should be processed within a given cycle.

FIG. 4 illustrates exemplary operations performed in a method of using a scan position to determine the order in which blocks should be processed within a given cycle. Additional, fewer, or different operations may be performed depending on the embodiment or implementation. In an operation 82, the probability of the following coefficient being non-zero is determined for each scan position. This may be done ‘off-line’ by using training data, such that a table common to both encoder and decoder is known in advance. Or it may be done dynamically, e.g. by explicitly measuring the probabilities in the previous frame.

In an operation 84, an ordered vector containing the scan positions is created, such that the scan position for which the next coefficient is most likely to be non-zero appears first, and the scan position for which the next coefficient is least likely to be non-zero appears last. In an operation 86, within a given cycle, those blocks whose scan position corresponds to the first entry in the ordered vector are processed first, followed by those blocks whose scan position corresponds to the second entry in the ordered vector, and so on until all blocks have been processed.

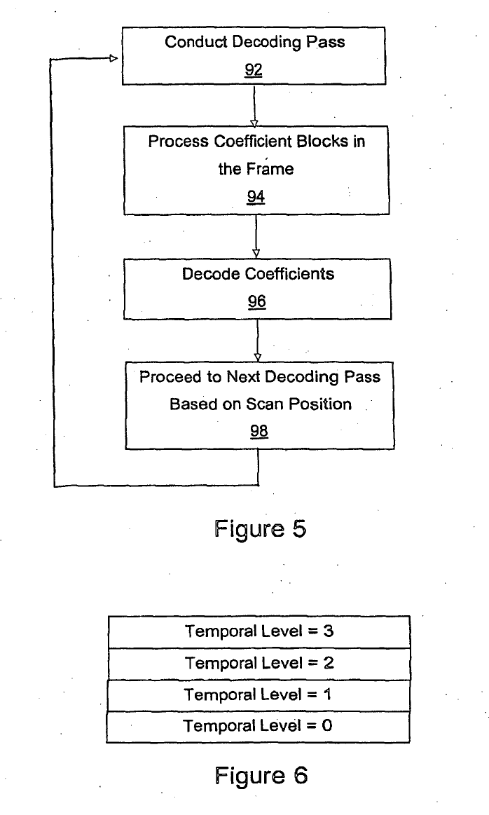

FIG. 5 illustrates exemplary operations performed in a method of decoding scalable video data. Additional, fewer, or different operations may be performed depending on the embodiment or implementation. In an operation 92, a decoding pass is conducted. As part of the decoding pass, in an operation 94, either all coefficient blocks in the frame are processed or a subset of the coefficient blocks are processed. For each of the coefficient blocks, zero or more coefficients are decoded according to an algorithm in an operation 96. In an operation 98, the method proceeds to a next decoding pass based on the scan position within each block. The order in which coefficient blocks are decoded is based on the probability the following coefficients are non-zero. The probability is determined based on previously decoded data or on one or more statistical profiles established in the decoder. This statistical profile can be signaled in the bit stream.

When blocks are encoded in order of the probability each next symbol will be zero, it is possible to truncate a FGS bit stream by a specified ratio such that the zero values (which are at the end) are removed. It may not, however, be desirable to truncate each slice by the same specified ratio. Instead, a different truncation ratio maybe used for each slice with the constraint that the overall ratio for the entire sequence achieves the specified ratio.

FIG. 6 illustrates a group of temporal levels for frames of the scalable video sequence. Each frame belongs to a particular temporal level. A truncation ratio can be linked to the temporal level for a given frame. For example, there will be a “base temporal layer” dictating the minimum frame rate (or frequency) of the scalable video sequence, and all frames belonging to this layer would have a temporal level of 0. There may be a “first set” of temporal enhancement frames that increase the frame rate, and each of these frames would have a temporal level of 1. There may be a “second set” of temporal enhancement frames that increase the frame rate still further, and each of these frames would have a temporal level of 2. Additional sets of temporal enhancement frames are permissible.

The quantization parameter (or QP) value of the encoded video is related to the temporal level of the frame, with a higher temporal level corresponding to a higher QP value. Similarly, the truncation ratio for a FGS slice is also related to the temporal level of the slice. For example, given a nominal truncation ratio of y, the truncation ratios used for slices of temporal level {0, 1, 2, 3, 4} may be {0.4y, 0.5y, 0.6y, 1.1y, 1.5y}. As such, the “temporal scaling vector” in this case can be written as {0.4, 0.5, 0.6, 1.1, 1.5}.

The optimal “temporal scaling vector” may be fixed, or it may be explicitly signaled in the bit stream. Alternatively, a discrete number of such “temporal scaling vectors” may be established, and the bit stream may contain a signal indicating which such vector is used for the current sequence.

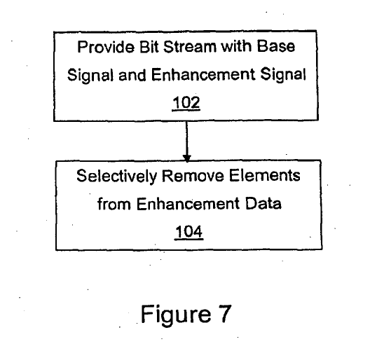

FIG. 7 illustrates exemplary operations performed in a method of coding or decoding a video sequence including a truncation ratio linked to the temporal level of a given frame. Additional, fewer, or different operations may be performed depending on the embodiment or implementation. In an operation 102, a bit stream containing a base quality signal and enhancement data to enhance the quality of the base quality signal is provided. In an operation 104, elements are selectively removed from the enhancement data, yielding a decodable bit stream with quality that is diminished yet greater than the quality of the base quality signal. The removed elements from the enhancement data can be removed by one or more elements from each slice of the enhancement data. The number of elements that are removed from a particular slice of enhancement data can be based, in part or in whole, upon the temporal level of the slice of enhancement data being considered.

In exemplary embodiments, a “truncation ratio” for the slice removed is adjusted by a scaling function based on the temporal level of the slice. The scaling function can involve multiplying the truncation ratio by a scalar number based on the temporal level of the slice. The set of scalar numbers for all temporal levels is determined either in advance or dynamically based on previously parsed content, and is not encoded in the bit stream. In an exemplary embodiment, the scaling function used for a given temporal level may vary dynamically from one slice to the next. Alternatively, the set of scalar numbers for all temporal levels is encoded in the bit stream. As yet another alternative, several discrete sets of scalar numbers can be known to the bit stream parser, and the set of scalar numbers to be used for a particular sequence is signaled in the bit stream.

While several embodiments of the invention have been described, it is to be understood that modifications and changes will occur to those skilled in the art to which the invention pertains. Accordingly, the claims appended to this specification are intended to define the invention precisely.

1. A method of decoding scalable video data, the method comprising:
identifying one or more coefficient blocks in a frame of scalable video data to be decoded during a decoding pass;
computing a scan position for each identified coefficient block;
processing the identified coefficient blocks in an order based in part on the computed scan positions corresponding to the identified coefficient blocks; and
decoding zero or more coefficients for each of the processed coefficient blocks.

2. The method of claim 1, wherein the order in which coefficient blocks are decoded is based upon a determined or assumed probability that coefficients following the scan position of the coefficient block are non-zero.

3. The method of claim 1, wherein the order in which coefficient blocks are decoded is based upon a determined or assumed probability of the next coefficient, defined as the coefficient in the next position relative to the scan position of the coefficient block, being non-zero.

4. The method of claim 3, wherein the coefficient blocks for which the next coefficient has a greater probability of being non-zero are decoded prior to all coefficient blocks for which the next coefficient has a lower probability of being non-zero.

5. The method of claim 4, wherein the probability is measured based on previously decoded data.

6. The method of claim 4, wherein the probability is based upon one or more statistical profiles established in a decoder.

7. The method of claim 6, wherein the one or more statistical profiles are signaled in the bit stream.

8. A method of processing scalable video data, the method comprising:
parsing a bit stream containing scalable video data;
selectively removing elements from one or more slices of scalable video data based on a temporal level of the one or more slices of scalable video data; and
forming a new bit stream that does not include the elements removed from the one or more slices of scalable video data.

9. The method of claim 8, wherein selective removal of elements from one or more slices of scalable video data is achieved by truncating the slice of scalable video data.

10. The method of claim 9, wherein a truncation ratio for the slice of enhancement data is adjusted by a scaling function based upon the temporal level of the slice.

11. The method of claim 10, wherein the scaling function involves multiplying the truncation ratio by a scalar number based on the temporal level of the slice.

12. The method of claim 11, wherein a set of scalar numbers for all temporal levels is determined in advance or dynamically based on previously parsed content, and is not encoded in the bit stream.

13. The method of claim 11, wherein a set of scalar numbers for all temporal levels is encoded in the bit stream.

14. The method of claim 11, wherein several discrete sets of scalar numbers are known to the bit stream parser, and the set of scalar numbers to be used for a particular sequence is signaled in the bit stream.

15. The method of claim 10, wherein the scaling function used for a given temporal level varies dynamically from one slice to the next.

16. A computer program product for coding a video sequence, the computer program product comprising:
computer code configured to:
identify one or more coefficient blocks in a frame of scalable video data to be decoded during a decoding pass;
compute a scan position for each identified coefficient block;
process the identified coefficient blocks in an order based in part on the computed scan positions corresponding to the identified coefficient blocks; and
decode zero or more coefficients for each of the processed coefficient blocks.

17. The computer program product of claim 16, wherein the order in which coefficient blocks are decoded is based upon any one of a determined probability and an assumed probability that coefficients following the scan position of the coefficient block are non-zero.

18. The computer program product of claim 16, wherein the order in which coefficient blocks are decoded is based upon any one of a determined probability and an assumed probability of the next coefficient in the scan position being non-zero, wherein the next coefficient is the coefficient in the next position relative to the scan position of the coefficient block.

19. The computer program product of claim 18, wherein the coefficient blocks for which the next coefficient has a greater probability of being non-zero are decoded prior to all coefficient blocks for which the next coefficient has a lower probability of being non-zero.

20. The computer program product of claim 19, wherein the probability is measured based upon previously decoded data.

21. The computer program product of claim 19, wherein the probability is based upon one or more statistical profiles established in a decoder.

22. The computer program product of claim 21, wherein the statistical profile is signaled in the bit stream.

23. A computer program product for coding a video sequence, the computer program product comprising:
computer code configured to:
receive a bit stream containing a base quality signal and enhancement data that enhances the quality of the base quality signal; and
selectively remove elements from the enhancement data, wherein the selective removal involves removing elements from a slice of enhancement data, and wherein the elements removed from the slice are based on a temporal level of the slice.

24. The computer program product of claim 23, wherein a truncation ratio for the slice is adjusted by a scaling function based upon the temporal level of the slice.

25. The computer program product of claim 24, wherein the scaling function involves multiplying the truncation ratio by a scalar number based on the temporal level of the slice.

26. The computer program product of claim 25, wherein the set of scalar numbers for all temporal levels is determined in advance or dynamically based on previously parsed content, and is not encoded in the bit stream.

27. The computer program product of claim 25, wherein the set of scalar numbers for all temporal levels is encoded in the bit stream.

28. The computer program product of claim 25, wherein several discrete sets of scalar numbers are known to the bit stream parser, and the set of scalar numbers to be used for a particular sequence is signaled in the bit stream.

29. The computer program product of claim 24, wherein the scaling function used for a given temporal level varies dynamically from one slice to the next.

30. A device for coding and decoding a video sequence, the device comprising:
a processor configured to execute instructions;
memory configured for storing a computer program; and
a computer program comprising instructions configured to cause the processor to:
identify one or more coefficient blocks in a frame of scalable video data to be decoded during a decoding pass;
compute a scan position for each identified coefficient block;
process the identified coefficient blocks in an order based in part on the computed scan positions corresponding to the identified coefficient blocks;
decode zero or more coefficients for each of the processed coefficient blocks;
receive a bit stream containing a base quality signal and enhancement data that enhances the quality of the base quality signal; and
selectively remove elements from the enhancement data, wherein the selective removal involves removing elements from a slice of enhancement data, and wherein the elements removed from the slice are based on a temporal level of the slice.

31. The device of claim 30, wherein the order in which coefficient blocks are decoded is based upon any one of a determined probability and an assumed probability that coefficients following the scan position of the coefficient block are non-zero.

32. The device of claim 30, wherein the order in which coefficient blocks are decoded is based upon any one of a determined probability and an assumed probability of the next coefficient in the scan position being non-zero, wherein the next coefficient is the coefficient in the next position relative to the scan position of the coefficient block.

33. The device of claim 32, wherein the coefficient blocks for which the next coefficient has a greater probability of being non-zero are decoded prior to all coefficient blocks for which the next coefficient has a lower probability of being non-zero.

34. The device of claim 33, wherein the probability is measured based upon previously decoded data.

35. The device of claim 33, wherein the probability is based upon one or more statistical profiles established in a decoder.

36. The device of claim 35, wherein the statistical profile is signaled in the bit stream.

37. The device of claim 30, wherein a truncation ratio for the slice is adjusted by a scaling function based upon the temporal level of the slice.

38. The device of claim 37, wherein the scaling function involves multiplying the truncation ratio by a scalar number based on the temporal level of the slice.

39. The device of claim 38, wherein the set of scalar numbers for all temporal levels is determined in advance or dynamically based on previously parsed content, and is not encoded in the bit stream.

40. The device of claim 38, wherein the set of scalar numbers for all temporal levels is encoded in the bit stream.

41. The device of claim 38, wherein several discrete sets of scalar numbers are known to the bit stream parser, and the set of scalar numbers to be used for a particular sequence is signaled in the bit stream.

42. The device of claim 37, wherein the scaling function used for a given temporal level varies dynamically from one slice to the next.
